(19) United States
(12) Patent Application Publication
(10) Pub. No.: US 2016/0122209 A1
(43) Pub. Date: May 5, 2016

(54) SELECTIVE FLUID RETRIEVAL AND TREATMENT SYSTEM FOR OIL AND WASTEWATER RECOVERY

(71) Applicant: Edward G. Newman, JR., Devine, TX (US)

(72) Inventor: Edward G. Newman, JR., Devine, TX (US)

(21) Appl. No.: 14/923,209

(22) Filed: Oct. 26, 2015

Related U.S. Application Data
(60) Provisional application No. 62/072,794, filed on Oct. 30, 2014.
(60) Provisional application No. 62/102,160, filed on Jan. 12, 2015.

(51) Int. Cl. C02F 1/40; C02F 1/00; B01D 21/30; B01D 17/02; B01D 21/02

(52) U.S. Cl. CPC C02F 1/40; B01D 17/0214; B01D 21/10; B01D 21/307; B01D 21/302; C02F 1/008; C02F 2101/32

(57) ABSTRACT

Apparatuses, systems, and methods for selectively separating, identifying, and recovering wastewater from an oil or gas operation is disclosed. In one embodiment, one or more selective retrieval systems may identify, track, target, and/or remove one or more separated layers of the wastewater. In one embodiment, a primary recovery tank is used, with each fluid layer being separated in and removed from the tank to one or more storage or recovery tanks. In other embodiments, a plurality of recovery tanks may be used, with each one having one or more selective retrieval systems. The plurality of recovery tanks may be interconnected via a manifold for additional fluid transfer and/or level control. The system may also use an internal or external static fluid level control to regulate the fluid level in one or more tanks.

### PRIORITY

This application claims priority to U.S. provisional patent application No. 62/072,794, filed on Oct. 30, 2014, and U.S. provisional patent application No. 62/102,160, filed on Jan. 12, 2015, the entire contents of each which is incorporated herein by reference.

### BACKGROUND OF THE INVENTION

1. Field of the Invention

The invention relates to an oil recovery and water treatment system, methods, and devices and more particularly to a selective fluid retrieval device for a multi-layered fluid or wastewater from an oil or gas well.

2. Description of the Related Art

In general, when an oil well is drilled, large amounts of water and other fluids are used to assist in various stages of oil production/recovery. For example, hydraulic fracturing is a well known well-stimulation technique in which, after a well is drilled, a high pressure fluid (that typically includes sand and chemicals suspended in water) is injected into a wellbore to create cracks in the deep-rock formations through which natural gas, petroleum, and brine will flow more freely. When the hydraulic pressure is removed from the well, fluids are typically recovered to the surface. The demands for the fresh water used in many hydraulic fracturing operations are placing pressure on water sources in some regions of the United States. Because of the high volumes of water needed for fracturing (e.g., in the Marcellus Shale, a typical hydraulic fracturing operation for a horizontal gas well in a tight shale formation requires from 3 to 5 million gallons of water over a 2-5 day period), the competing demand driven by industrial, municipal, and agricultural users has in some cases decreased the availability of fresh water and increased associated costs. Along with higher acquisition costs for fresh water, water disposal costs have also increased.

“Produced water” is a term used to describe water produced from a wellbore that is not a treatment fluid. This is typically naturally occurring water found in underground formations that flows to the surface during the lifespan of the well. In contrast, the term “flowback” is a water-based fluid that flows back to the surface following well treatment (such as hydraulic fracturing). The fluid typically contains (in addition to water) clays, chemical additives, dissolved metal ions, and total dissolved solids (TDS). TDS is a measure of dissolved matter in water, such as salts, organic matter, and minerals. In general, flowback water and produced water are generally considered as waste byproducts of oil and gas production, and may be referred to generically (whether individually or collectively) as wastewater. Wastewater presents many difficulties, including transportation over long distances and compliance with local, federal, and environmental regulations related to its disposal, and requires many disposal, treatment, and transportation considerations.

Rather than disposal of the wastewater, various water management alternatives have been developed. Rather than disposing all of the wastewater, particularly the small amounts of oil present in the water, various oil recovery and water treatment systems have been utilized, which typically use some type of simple separation process. The goal of any separation process is to separate and/or isolate the different components of the fluid to be separated. Once separated, each individual component can then be further refined/separated, sold (in the case of skim oil), or disposed of (in the case of hazardous wastes).

Some of these known processes only separate the oil from the produced water, and others provide minimal separation processes that remove the contaminants from the water to avoid (or minimize) disposal or injection well plugging or other pumping of underground aquifers. One well-known method uses a “gun barrel” (or “wash tank”) to separate and sell crude oil present in the produced water. Many variations to the gun barrel technique are known, with some offering higher efficiencies and other improvements. Other water treatment technologies include flocculation, coagulation, sedimentation, filtration, vibration, micro bubble air flotation, radio frequency, microwave, chemicals, ultrasound, and lime softening water treatment processes. Still other techniques may include membranes, reverse osmosis membranes, thermal distillation, evaporation and/or crystallization processes, which all may be used to treat TDS. In general, existing wastewater treatment techniques remain ineffective and present may disadvantages, such as large capital and operating costs, long installation time, large footprint space, and low operating efficiencies. Further, various operational parameters are often needed, such as constant input of produced water or batch (non-continuous) input of produced water. Still further, while some of the known techniques are able to separate one layer or component from the wastewater, they often encounter significant problems in separating other components from the wastewater. For example, existing technologies encounter many difficulties and are inefficient in identifying, recovering, and separating individual layers from wastewater, in particular produced water, oil based mud, and tank bottoms.

A need exists for an improved method and system for recovering oil and other component layers from wastewater from a well with a need for high efficiency, reduced cost, smaller footprint, easily interfaced to the well sites and locations, and mobility. The improved system described in this application solves one or more of these problems and offers significant cost savings by enhanced/improved recovery of oil, reduction of disposal fees, reduction of transportation expenses, re-use of water, and elimination of underground pumping/disposal of produced water.

### SUMMARY OF THE INVENTION

Apparatuses, systems, and methods for selectively separating, identifying, and recovering wastewater or produced water from an oil or gas well is disclosed. While one embodiment is directed to the oil industry, the described selective fluid retrieval system is also useful in many other industries with complex and/or multi-component layers of fluids, such as wastewater, water, mining, agriculture, aquatic farming, and refinery applications.

In one embodiment, the improved system uses one or more selective retrieval systems that tracks, targets, and removes one or more layers of the wastewater from a given container or tank. In one embodiment, a primary recovery tank is used, with each fluid layer being separated in and removed from the tank to one or more storage tanks. In other embodiments, a plurality of recovery tanks may be used, with each one having one or more selective retrieval systems. The plurality of recovery tanks (or one or more of the recovery tanks) may be interconnected via a manifold for additional fluid transfer (such as water) from one or more of the tanks. The system may also use a static fluid level control to regulate the fluid level in one or more tanks for the separations treatment residence time and allowing for fixed layer removal locations within the treatment tanks. The fixed or static fluid level control may be internal or external to the relevant fluid level control tank.

In one embodiment, the disclosed recovery system comprises an input container that holds a plurality of fluid layers of wastewater, a plurality of storage tanks, a sensor coupled to the input container that is configured to detect one or more of the plurality of fluid layers, and a selective fluid recovery device in the input container that is configured to retrieve at least some of the fluid in at least one of the plurality of fluid layers. Additional selective fluid recovery devices may be used in the input container to retrieve additional fluid layers, and in some embodiments a single retrieve device utilizes multiple suction devices (whether vertically moveable, fixed at a given vertical height, and/or floating) to retrieve multiple fluid layers. In some embodiments, additional recovery tanks may be utilized to further separate one or more of the layers retrieved from the input container. The storage tanks may be configured to receive fluid from one or more of the input containers and/or recovery tanks. In some embodiments, a lake take may be used to hold recycled water.

The disclosed system may also utilize a control system that couples all of the electronic components of the system together, including the selective retrieval device and sensor and any associated pumping systems, and is configured to selectively turn off and on pumps to retrieve fluid from the selective retrieval device, to selectively position the selective retrieval device in a given layer of fluid, and to modify the flow rates between the input container, storage tanks, and/or recovery tanks.

In another embodiment, a fluid retrieval system for recovering fluids from wastewater is disclosed that comprises a sensor configured to detect a height of each of a plurality of fluid layers in a container and a selective fluid recovery device configured to retrieve fluid from one or more of the plurality of fluid layers based on the detected heights. The sensor may be laser, radar, sonar, etc., and may be configured to detect one or more of the plurality of fluid layers at a plurality of time intervals and/or continuously. The sensor may be mounted to the top of the container and coupled to a control system. The selective retrieval device may include multiple retrieval or suction points to retrieve fluid from a plurality of fluid layers, or may have one retrieval point that is configured to move vertically in the container to selectively target and retrieve fluid from an individual fluid layer. In other embodiments, multiple sensors may be used for a given container and/or multiple retrieval devices coupled to the same sensor in a given container.

In another embodiment, a method for treating used fluids from an oil or gas operation is disclosed that comprises receiving one or more used fluids at an input container, separating the received fluids into a plurality of fluid layers, selectively positioning a retrieval device into at least one of the plurality of fluid layers, and retrieving a fluid portion from at least one of the plurality of fluid layers through the one or more selective retrieval devices. In some embodiments, fluid from each of the fluid layers is targeted and retrieved by one or more fluid recovery devices. The method may further comprise removing one or more of the plurality of fluid layers into a plurality of recovery containers, separating the fluid in each of the recovery containers into a plurality of additional fluid layers, selectively positioning a retrieval device in one or more of the plurality of additional fluid layers, and retrieving fluid from the one or more plurality of additional fluid layers by the one or more retrieval devices.

### BRIEF DESCRIPTION OF THE DRAWINGS

The following drawings form part of the present specification and are included to further demonstrate certain aspects of the present invention. The invention may be better understood by reference to one or more of these drawings in combination with the detailed description of specific embodiments presented herein.

FIG. 1 illustrates a schematic diagram of an oil recovery system according to one embodiment of the present disclosure.

FIG. 2A illustrates a schematic diagram of a mechanized fluid retrieval tool according to one embodiment of the present disclosure.

FIG. 2B illustrates a schematic diagram of a non-mechanized fluid retrieval tool according to one embodiment of the present disclosure.

FIG. 2C illustrates a schematic diagram of a combination mechanized and non-mechanized fluid retrieval tool according to one embodiment of the present disclosure.

FIG. 2D illustrates a schematic diagram of a non-mechanized fluid retrieval tool according to one embodiment of the present disclosure.

FIG. 3 illustrates a schematic diagram of a control system for the oil recovery platform in FIG. 1 according to one embodiment of the present disclosure.

FIG. 4 illustrates a schematic diagram of an oil recovery and fluid treatment system according to one embodiment of the present disclosure.

FIG. 5 illustrates one embodiment of a method for selectively removing one or more fluid layers according to one embodiment of the present disclosure.

### DETAILED DESCRIPTION

Various features and advantageous details are explained more fully with reference to the nonlimiting embodiments that are illustrated in the accompanying drawings and detailed in the following description. Descriptions of well known starting materials, processing techniques, components, and equipment are omitted so as not to unnecessarily obscure the invention in detail. It should be understood, however, that the detailed description and the specific examples, while indicating embodiments of the invention, are given by way of illustration only, and not by way of limitation. Various substitutions, modifications, additions, and/or rearrangements within the spirit and/or scope of the underlying inventive concept will become apparent to those skilled in the art from this disclosure. The following detailed description does not limit the invention.

Reference throughout the specification to “one embodiment” or “an embodiment” means that a particular feature, structure, or characteristic described in connection with an embodiment is included in at least one embodiment of the subject matter disclosed. Thus, the appearance of the phrases “in one embodiment” or “in an embodiment” in various places throughout the specification is not necessarily referring to the same embodiment. Further, the particular features, structures, or characteristics may be combined in any suitable manner in one or more embodiments.

In one embodiment, the selective retrieval system embodied in this disclosure provides a novel approach to recycling produced water in oilfield applications and is able to fully recycle all of the produced water from an oil well. Produced water may in some instances include flowback water and other tank bottoms, and the flowback may include water, oil, polymers, minerals, and other components that are discharged from the well, including as a result of the fracturing operations and the following mill out. The term “wastewater” is intended to include both produced water and flowback water (both individually and collectively). The disclosed system provides significant advantages, and can eliminate or minimize the use of pumping wastewater into underground aquifers and other disposals using injection wells. Further, the described system is configured to isolate, target, and retrieve any oil present in the wastewater. Still further, the described system is configured to separate and selectively recover all of the fluid layers in a given body of a multi-component/layer fluid. In another embodiment, the described system can be utilized to recover oil from sources other than produced water, such as a contaminated water body or river. While one embodiment is directed to the oil industry, the described selective fluid retrieval system is also useful in many other industries with complex and/or multi-component layers of fluids, such as wastewater, water, mining, agriculture, aquatic farming, and refinery applications.

### Fluid Layer Recovery System

In one embodiment, the fluid recovery system embodied in this disclosure comprises at least three primary steps. First, the system recognizes the different individual fluid (or solid) layers or phases of any multi-component/layer fluid in a given tank, container, or body of water. Second, the system determines and tracks the height, level, and/or thickness of each individual layer without respect to the static level of the tank. Third, the system selectively targets each individual fluid layer within the container and removes some or all of the fluid layer for relocation to another tank or process. In one embodiment, each of these steps and/or operations is done automatically by an integrated control system.

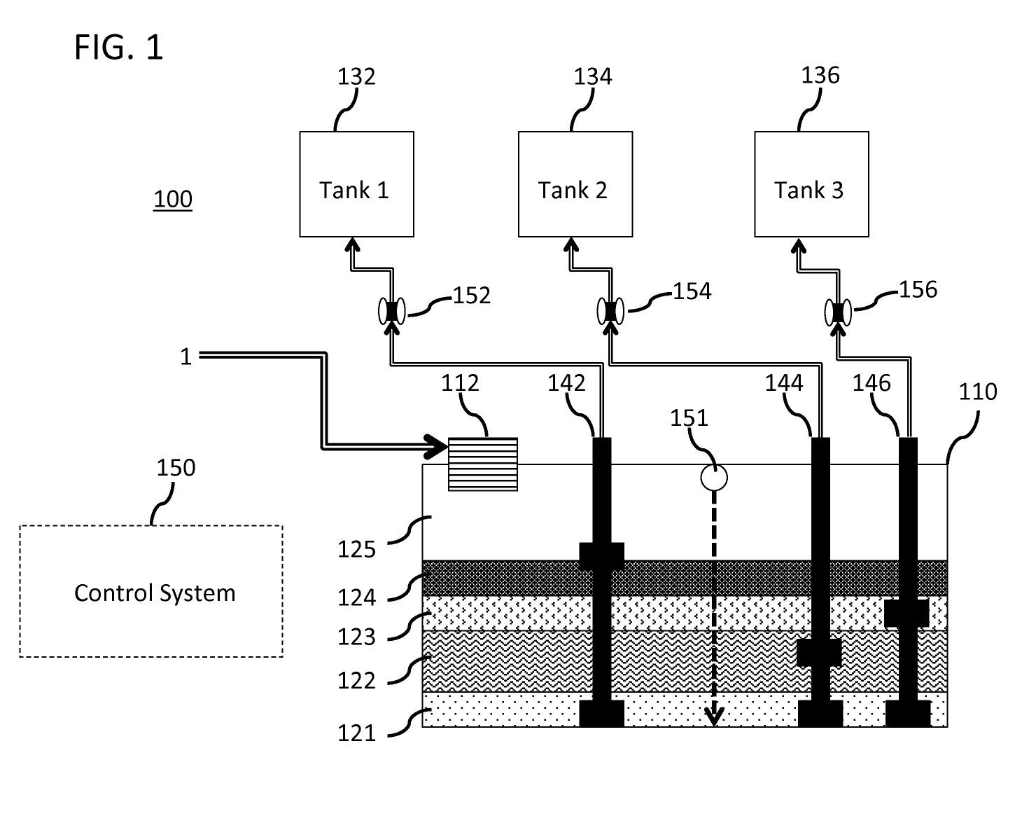

FIG. 1 illustrates one embodiment of improved fluid recovery system 100. In one embodiment, fluid recovery system 100 may include one or more base tanks 110, one or more primary layer or skim oil tanks 132, one or more secondary layer or water/sludge tanks 134, 136, one or more retrieval systems 142, 144, 146, one or more pumping systems 152, 154, 156, sensor 151, and control system 150. FIG. 1 shows a simplified cross-sectional side view of tank 110. In one embodiment, tank 110 is configured to hold produced water, wastewater and/or or other flowback water or recovered water from an oil or gas well or similar operation. In other embodiments, the wastewater may be received from any other source that comprises multi-components/layers in the wastewater. In one embodiment, the wastewater is separated into a plurality of phases or layers within tank 110, such as a top or floating layer 124, intermediate upper layer 123, middle layer 122, and bottom layer 121. The tank may also include an upper air layer or section 125 that does not comprise any liquids or solids and which is variable based on the amount of fluid present in the container. In some embodiments, the height of upper air layer 1235 is substantially constant, such as when a static control system is utilized to keep the amount of fluids present in a container to be substantially static and/or fixed. In one embodiment, top layer 124 is substantially comprised of oil, upper intermediate layer 123 is a PAD layer that comprises used polymers and bacteria bodies, middle layer 122 is substantially comprised of water, and bottom layer 121 is substantially comprised of sludge. One of ordinary skill in the art will recognize that a layer itself may be comprised of multiple sub-layers and that any layer may include components other than those primarily identified as the layer. The layers can occur naturally based on the different densities of the components in the produced water, and in other embodiments can be assisted to separate via mechanical or chemical means as is known in the art. For example, it is well known that an emulsion breaker can be used to free emulsified oils and a chemical (such as biocide) can be used to kill any bacteria present in the produced water. Further, prior to introduction into base tank 110, wastewater may be directed through screen 112, which may be a “shale” shaker screen with a desander hydrocyclone, desilter hydrocyclone, centrifuge, or sieve that can filter out any large or fine solids, such as sand, rock, concrete, and cuttings for removal into a container for disposal.

In one embodiment, base tank 110 is a frac tank located at the land lease where the well site is located. In some embodiments, it is a vertical tank and in other embodiments it may comprise a pond or other reservoir. In still other embodiments, it is a non-stationary tank that can be moved from location to location. Thus, a tank may or may not be mobile, and may include wheels coupled to the tank for easy transportation, which is common to frac tanks. In operation, wastewater is provided to base tank 110 via conduit and/or piping system 1 either in a continuous process or in a batch by batch process in irregular intervals. The produced water can be provided from a single well or by a plurality of wells via a variety of mechanisms, including direct piping conduits and container trucks. In one embodiment, a tank may be any pressurized or non-pressurized container, vessel, or tank configured to hold fluids. If non-pressurized, the pressure of the tank may be approximately atmospheric pressure, and any gas present in the incoming wastewater streams is simply bled off to atmosphere from base tank 110. In many instances, however, the wastewater may include dissolved gas, and as a safety factor many tanks or vessels are operated under pressure in which any dissolved gas is routed out and scrubbed (and potentially combusted) so as to not directly vent any unwanted gas to the atmosphere. The separation and fluid retrieval operations and principles described herein are also relevant for pressurized containers and can be used in any flowback production management where pressurized operating systems are necessary. As one example, the disclosed tanks may include pressurized containers such as 3-phase separators commonly used during flowback and with production facilities. For these systems, the container may also include a variety of gauges, probes, sensors, and other devices to measure any necessary parameters of the fluids within the tank.

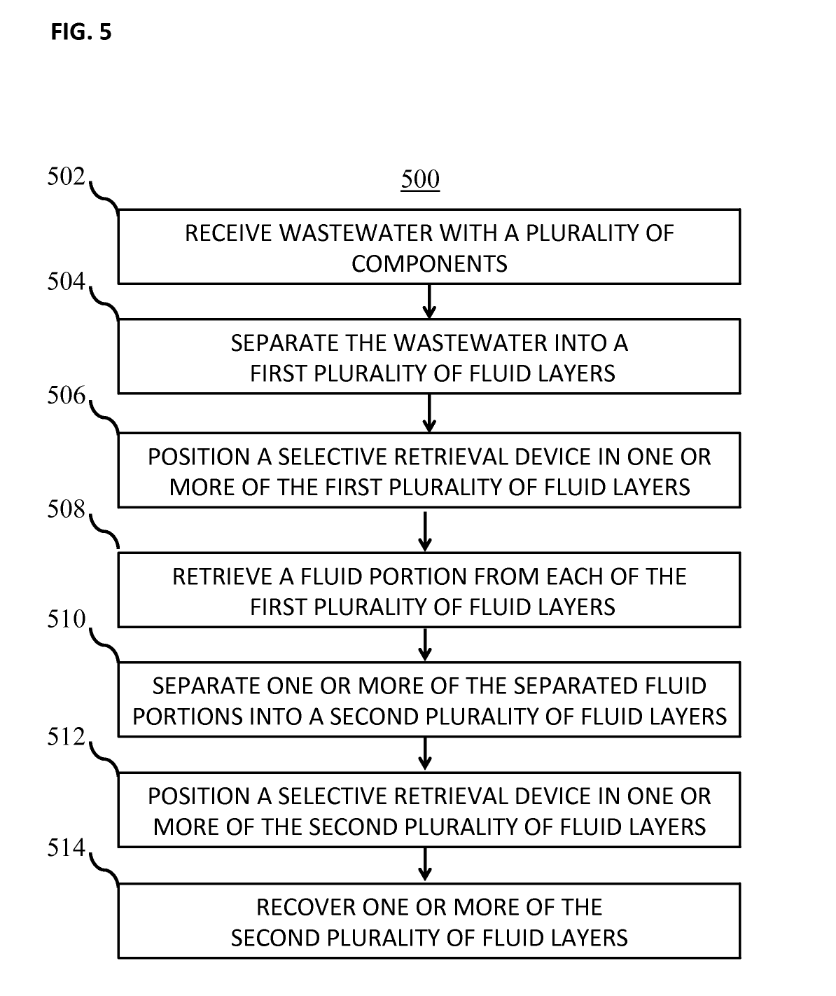

In one embodiment, fluid recovery system 100 filters, separates, targets, isolates and recovers the various layers of the wastewater in base tank 110. In one embodiment, oil layer 124 of tank 110 is recovered to one or more skim oil recovery tanks 132. In another embodiment, fluid recovery system 100 retrieves and/or isolates water layer 122 of tank 110 into one or more water recovery tanks 134. In one embodiment, sludge/residue layer 121 of tank 110 is recovered into second layer recovery tank 136, and in other embodiments, the sludge layer is recovered into one or more sludge tanks. In another embodiment, the PAD or other upper intermediate layer 123 of tank 110 is recovered into a third layer recovery tank (not shown). In certain embodiments, each of these tanks may be further processed or separated to further recover or isolate the primary components in each tank with a greater efficiency (such as further shown in FIG. 5). In one embodiment, a portion of each fluid layer is left in base tank 110 so as to limit the unintentional recovery of any other layers or components near a layer differential or boundary between the adjacent fluid layers.

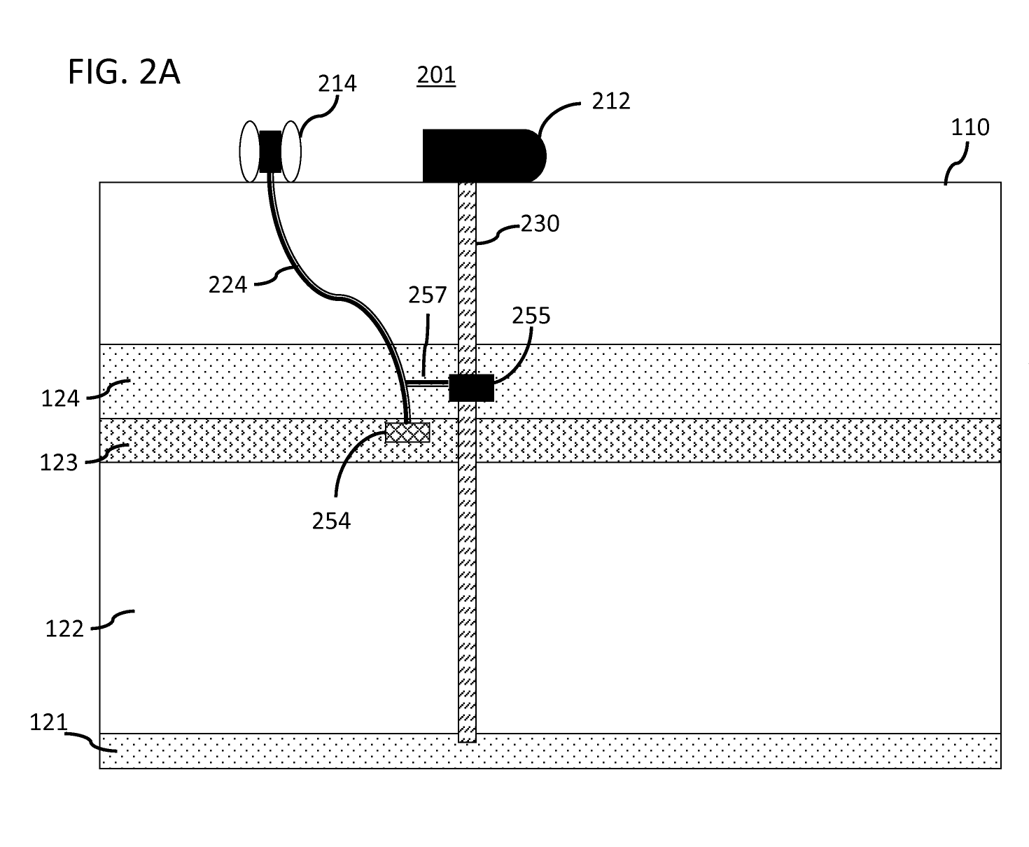

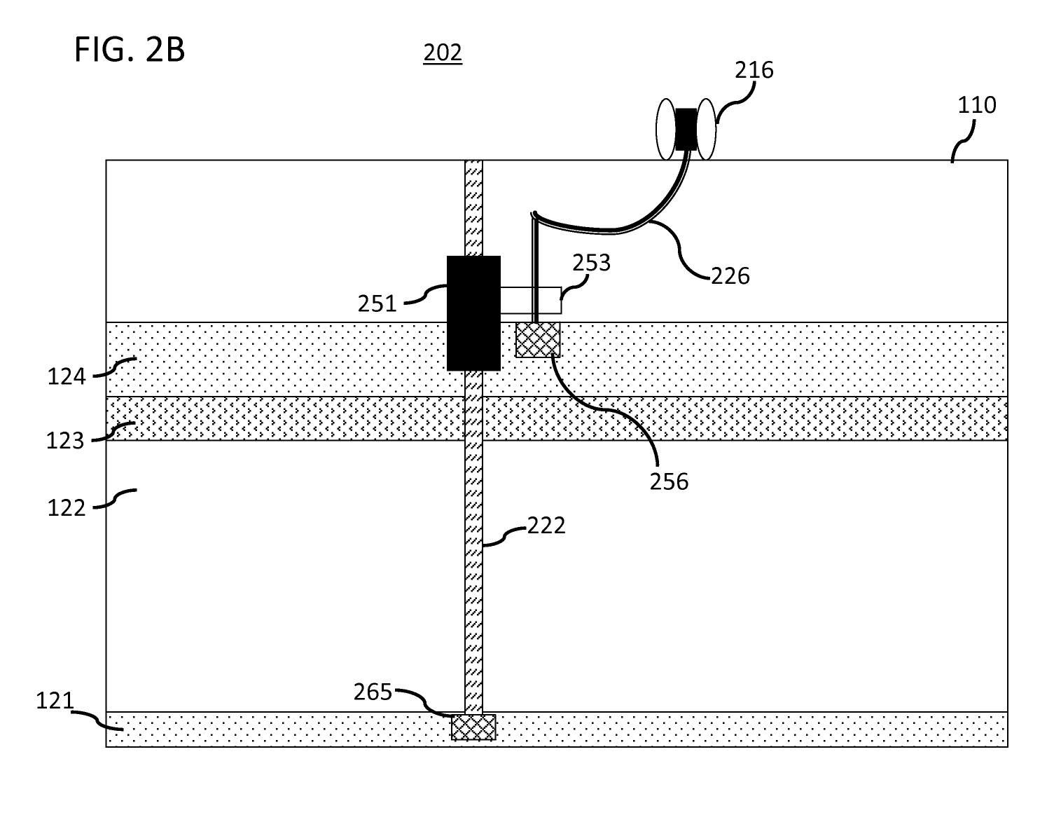

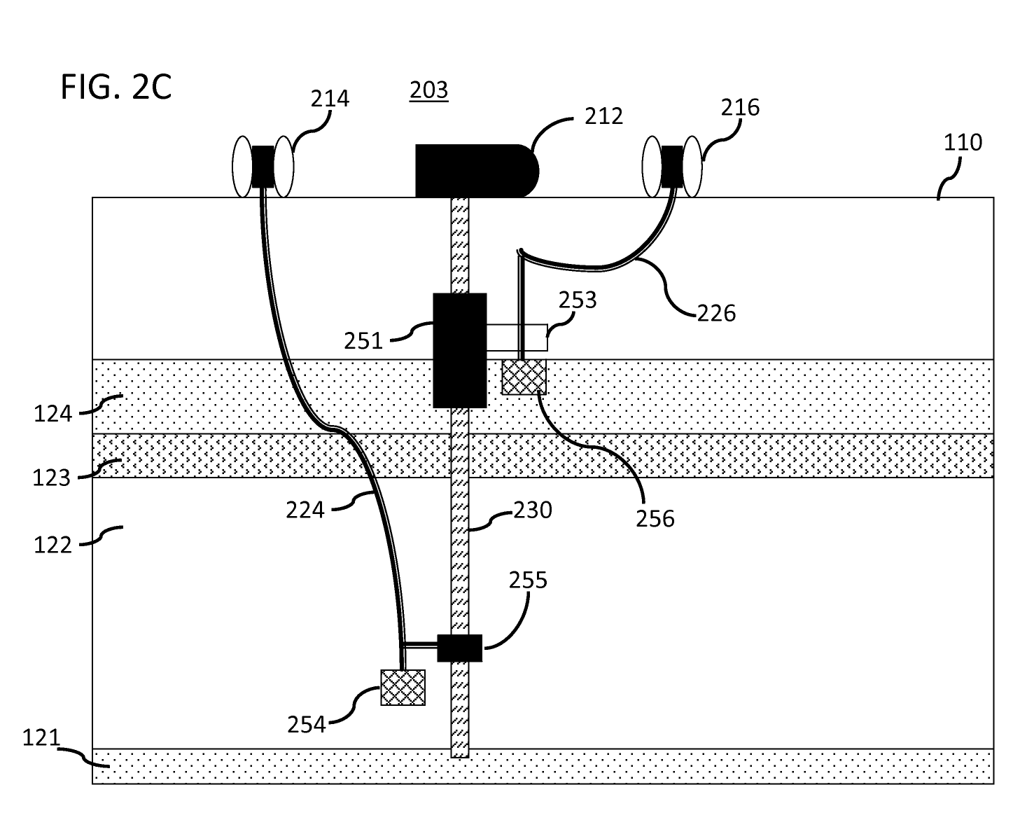

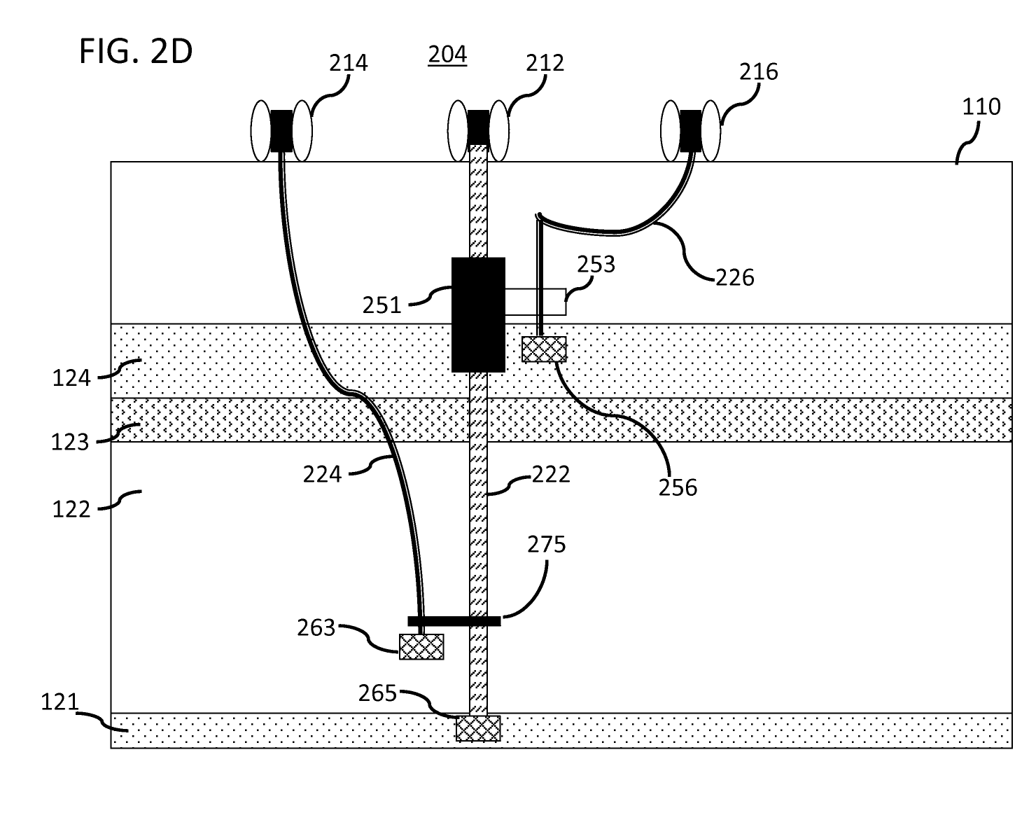

In one embodiment, fluid recovery system 100 comprises one or more selective surgical removal or retrieval systems 142, 144, 146. Each selective retrieval system 142, 144, 146 comprises one or more suction points to withdraw fluid from a particular layer. While three fluid retrieval systems are shown in FIG. 1, more or less are possible. Further, while the retrieval systems shown in FIG. 1 appear the same for brevity and simplicity, each selective retrieval system 142, 144, 146 may have different retrieval components. For example, each one of the retrieval systems may be one or any combination of the retrieval systems shown in FIGS. 2A-2D. In one embodiment, one or more selective retrieval systems exist for each layer in the wastewater. Thus, first selective fluid retrieval system 142 may be configured to remove a portion of the oil from oil layer 124, which is routed through pump 152 to tank 132. Second selective fluid retrieval system 144 may be configured to remove a portion of the water layer from PAD layer 122, which is routed through pump 154 to tank 134. Third selective fluid retrieval system 146 may be configured to remove a portion of the PAD layer from PAD layer 124, which is routed through pump 156 to tank 136. In other embodiments, one or more of the retrieval systems are configured to retrieve fluids from multiple fluid layers. In this embodiment, a single retrieval device may be configured to move a plurality of vertical heights to suction or retrieve fluid from a plurality of fluid layers sequentially or may be configured with multiple suction points to retrieve fluid from a plurality of fluid layers simultaneously. Thus, only one retrieval system may be used to retrieve fluids from a plurality of fluid layers within base tank 110. In another embodiment, multiple pumps or suction devices may be coupled to each selective retrieval device to retrieve the different fluid layers. The retrieval systems may be robotic and/or mechanized, such that a retrieval device moves vertically within base tank 110 a predetermined distance based on the determined height of the fluid levels. In other embodiments, the retrieval systems may include one or more fixed suction points that operate at a predetermined vertical height and/or are coupled to a float (so as to keep the suction point within or on a predetermined fluid layer). Still further, a single retrieval system may be utilized to recover fluids from oil layer 124 and/or PAD layer 123, while other retrieval systems, such as a bottom sludge suction filter and a water manifold can remove fluid from the other levels in base tank 110. In one embodiment, multiple layers in base tank 110 can be automatically tracked, targeted, and removed individually and independently at the same time, via one or more retrieval devices. In one embodiment, the fluid recovery device is configured to retrieve at least some of the fluid in one of the plurality of fluid layers without retrieving substantially any of the fluid in the other fluid layers. In other words, the fluid retrieval system is configured to selectively target and retrieve fluid from an individual layer without retrieving unwanted fluid from adjacent layers. The recovery operations can be performed on a static or non-static level of wastewater. A non-static level of fluid in a container requires selective retrieval devices that are more complex, such as the robotic tool that moves vertically a predetermined distance, whereas a static level of fluid allows less-complex retrieval devices to be used, such as floats coupled to a retrieval device and/or fixed point retrieval devices.

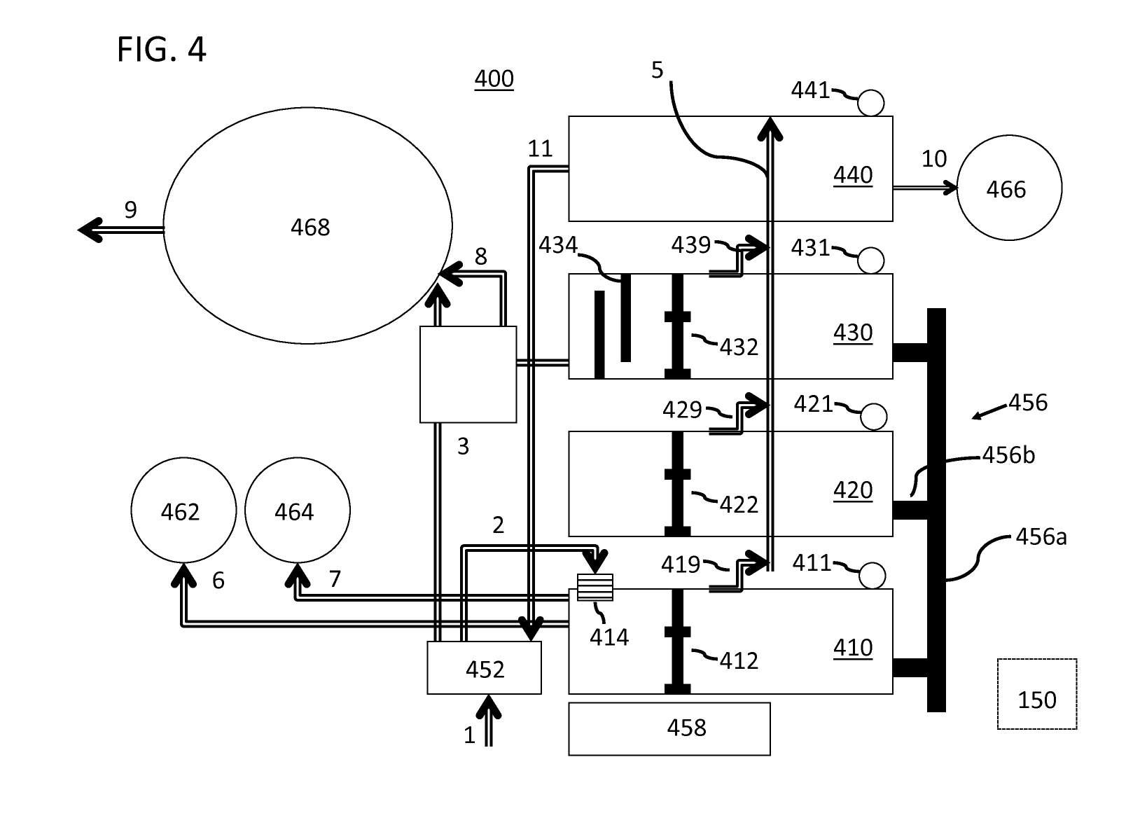

In one embodiment, water layer 122 of tank 110 is connected to a plurality of other tanks via a manifold (see FIG. 4). The manifold is configured to allow water flow from tank to tank and in one embodiment allows a fluid height (such as the water) to be set at a constant height based on water movement via the manifold and other fluid leveling mechanisms Thus, in one embodiment, a separate mechanized surgical tool is not necessary to isolate the water in tank 110 in the same way as oil layer 124 or PAD layer 123. For example, in addition to water being retrieved through a manifold, a floating system or other non-mechanized selective removal system that remains substantially fixed at a given height can be used on the water layer to move the retrieved water to another tank.

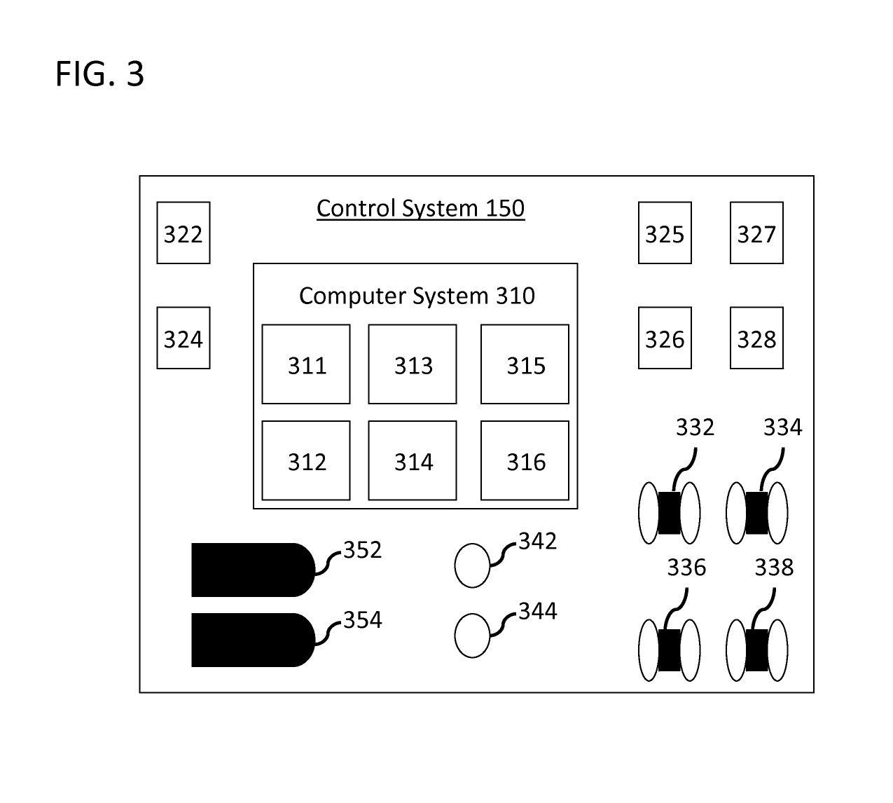

In one embodiment, fluids recovery system 100 comprises sensor 151, which is configured to detect the various layers in the base tank and may be configured to detect the height of each layer. Sensor 151 may be mounted inside an upper portion of tank 110 and may be coupled to or part of control system 150 (discussed more in relation to FIG. 3). In one embodiment, sensor 151 is a sonar sensor, but in other embodiments includes a laser, ultrasonic, radar, and even a magnetic float sensor. In one embodiment, a plurality of sensors can be utilized within a single tank, such as a radar system and a laser system, for increased accuracy of determining the height of the fluid layers. As another example, some fluid layers may be more accurately determined by different sensors, so one embodiment utilizes a first sensor to detect the height of one or more layers and a second sensor detect the height for other layers. In one embodiment, radar or sonar sensor 151 constantly emits signals that travel the entire vertical distance of base tank 110, or at least the vertical portion of the tank that comprises the fluid layers. As the signals encounter or hit different phases, layers, or components of the wastewater, the signals (or a portion of the signals) are reflected back to sensor 151. A signal from the sensor (such as 4-20 ma, pulse, or others) is provided to control system 150. Based on the received signals, a control computer within control system 150 can determine the relative heights of each layer and send signals to one or more retrieval systems 142, 144, 146 to perform any necessary operations, such as instructions to mechanical pumps to start/stop pumping and instructions to mechanized removal suction points to move up or down based upon data received by sensor 151 and various calculations/programs performed by control system 150. In one embodiment, the thickness of a specific layer may be calculated based on determining the height of the layer below or above the specific layer. For example, based on measurements taken by sensor 151 and corresponding signals received by control system 150, the height of oil layer 124 may be determined to be Height A, and the height of PAD layer 123 or water layer 122 may be determined to be Height B, and thus the thickness of the oil layer may be calculated as Height A minus Height B. Similar calculations may be performed for the remaining fluid layers.

### Selective Retrieval System

As mentioned above, fluid recovery system 100 comprises one or more selective retrieval systems that are configured for retrieval of one or more fluid layers from base tank 110. Such retrieval systems may be mechanized (such as shown in FIG. 2A) or non-mechanized (such as shown in FIGS. 2B and 2D), or a combined mechanized/non-mechanized system (such as shown in FIG. 2C). In some embodiments, fluid recovery system 100 may comprise a plurality of selective retrieval devices, wherein one or more may comprise a mechanized retrieval system and one or more may comprise a non-mechanized retrieval system. Thus, in one embodiment, referring now to FIG. 1, retrieval system 142 may be a mechanized/robotic fluid retrieval system, retrieval system 144 may be a non-mechanized fluid retrieval system, and retrieval system 146 may be a combination mechanized/non-mechanized fluid retrieval system.

FIG. 2A illustrates one embodiment of selective fluid retrieval system 201, which is mechanized and/or robotic. Retrieval system 201 operates as a robotic and/or mechanized surgical/removal tool that moves up and down between a plurality of fluid layers in a tank to selectively remove a portion of an individual fluid layer. In one embodiment, retrieval system comprises gear motor 212 that mechanically raises and lowers suction or retrieval device 254 along vertical member 230, which may be a threaded rod. In other embodiments, different mechanisms can be used instead of a threaded rod, such as hydraulic lever or lift, as well as scissors type lift. Suction tool and/or device 254 may be any device that can retrieve or suck fluid from an individual layer, including a nozzle, hose inlet, syringe, and other similar mechanisms or devices. Suction tool 254 may also include a suction screen to filter out solids or other debris. Suction tool 254 may be coupled to rod 230 by fastening member 255, which may be a threaded nut or other similar fastener that is configured to move up or down in response to rotation of threaded rod 230. In one embodiment, flexible hose or pipe 224 connects suction tool 254 to an air-operated diaphragm (AOD) or other pump 214. Hose 224 is flexible such that it can move with movable fastening member 255. Fastening member 255 may be directly connected to suction device 254 or hose 224 or be coupled to hose 224 via holding wire or rod 257. In some embodiments, the disclosed retrieval system comprises a sensor (such as sensor 151), while in other embodiments the disclosed retrieval system is merely coupled to a sensor.

A certain amount of revolutions is correlated to the height that fastening member 255 (and thus suction tool 254) moves on the threaded rod for those revolutions. In one embodiment, control system 150 is programmed to move fastening member 255 a predetermined number of revolutions to operatively place suction device 254 at the desired layer based on data from sensor 151 and/or control system 150. In one embodiment, as shown in FIG. 2A, suction tool 254 is selectively positioned or placed in PAD layer 123. The PAD layer is a layer that primarily comprises used polymers and bacteria bodies. In existing technologies, the PAD layer is particularly problematic to isolate because it exists between the oil layer and the water layer and neither floats on top nor sinks to the bottom. In one embodiment, after tool 254 is positioned, control system 150 signals AOD or other pump 214 to begin pumping PAD layer through fluid hose inlet or nozzle 254 (with a suction screen) that is coupled to the surgical tool, which may be routed through the appropriate pipeworks to a container, such as tank 136. After the desired amount of fluid is retrieved, the control system signals pump 214 to stop pumping. Various control logic or predetermined parameters may be used to determine the amount or time of fluid removed from an individual layer. In one embodiment, sensor 151 (shown in FIG. 1 but not in FIGS. 2A-2D) actively measures the depth of the relevant fluid layer (such as the PAD layer) and based on those measurements, control system 150 stops the pumping and/or retrieval once the fluid layer reaches a minimum threshold, such as a when the fluid layer reaches 4 inches in height. Such measurements may be done in real time or near real time as the fluid is retrieved. In other embodiments, sensor 151 may be programmed to operate at selected time intervals to measure the height of the fluid layers and/or be operated continuously for a predetermined amount of time. Thus, at a first fluid layer height the retrieval tool begins fluid retrieval and at a second fluid layer height the retrieval tool stops fluid retrieval. In some embodiments, based on the depth of the fluid layer being retrieved, surgical tool 254 may be moved vertically to compensate for the variable fluid depth and/or height while the surgical tool is actively retrieving fluid. Surgical tool 254 may be moved to another one of the plurality of layers (such as oil layer 124 or water layer 122 or sludge layer 121) for fluid retrieval from that layer, or remain substantially in the same place or same fluid level for subsequent fluid retrieval from that fluid layer.

FIG. 2B illustrates one embodiment of selective fluid retrieval system 202, which is a floating non-mechanized retrieval system. In one embodiment retrieval system 202 comprises float 251 that is configured to float on top of or substantially within oil layer 124 in base tank 110. The float may be coupled to a vertical rod or pipe 222 in a variety of mechanisms, such as by fitting around pipe 222 or by being attached to pipe 222 via one or more vertically moveable fastening mechanisms. In one embodiment, float 251 has a hole in the middle through which pipe or rod 222 is inserted, and float 251 is configured to vertically travel rod 222 with the variable height of oil layer 124. Hose 226 and suction screen 256 may be coupled to an AOD or other pump 216 that is coupled to control system 150. Float 251 may be coupled to hose 226 via holding wire, plate, or rod 253. Float 251 rises and falls with the height of the produced water and/or oil layer in the base tank 110 and maintains a relative constant suction point for the hose. When sensor 151 and/or control system 150 determines a predetermined amount of oil layer height (such as eight inches), control system 150 sends a signal to pump 216 to retrieve oil through suction screen 256 and hose 226 of floating retrieval system 202. In one embodiment, control system 150 is configured to turn off pump 216 when oil layer 124 reaches a certain level, such as 4 inches, as detected by sensor 151. In one embodiment, an inlet or nozzle of hose 226 (with suction screen 256) is rigidly attached to float 251 (such as by fastener 253) such that as float 251 rises and falls the hose inlet likewise rises and falls. Hose 226 is flexible such that it can move with movable float 251. In other embodiments, a float system may be configured to match the density of a given layer (such as water layer 122) such that it may float in other layers besides oil layer 124. For example, in some cases, float 251 may be built to float on top of water layer 122 with a connected suction point configured to retrieve fluid from the water layer or any adjacent layer to the water layer. In still other embodiments, a single retrieval device 202 may include a plurality of floating suction systems each configured to float in one of the plurality of fluid layers.

In one embodiment, a fluid retrieval system may include a hose inlet or nozzle with suction screen 265 that is substantially fixed on or near the bottom of the container. In one embodiment, the hose may be part of and/or coupled to vertical pipe 222, and in other embodiments a separate hose (not shown) is coupled to suction screen 265. Because sludge layer 121 typically resides on the bottom portion of base tank 110, this embodiment is configured to remove a portion of the fluid from sludge layer 121 without any vertical movement of a float system or mechanized tool. In one embodiment, once sensor 151 and/or control system 150 measures the height of sludge layer 121 to be over eight inches, control system signals 150 an AOD or other pump (not shown in FIG. 2B) to begin pumping the sludge through suction screen 265 and pumped to a sludge retrieval tank.

FIG. 2C illustrates one embodiment of selective fluid retrieval system 203, which is a combination of a mechanized retrieval system and a non-mechanized retrieval system. In one embodiment, this system is effectively a combination of the systems described in FIGS. 2A and 2B. In this embodiment, a single retrieval platform or device combines a float system (such as 251) that floats on top of or within a fluid layer (such as oil layer 124) and a mechanized surgical/retrieval tool (such as 254) into a single system. In other words, fluid retrieval system 203 comprises a plurality of selective retrieval devices. As shown in FIG. 2B, gear motor 212 is attached to threaded rod 230, which is coupled to each of the retrieval devices. Each retrieval device works substantially the same as described in the preceding paragraphs. As described in relation to FIG. 2B, a float system 251 is coupled to rod 230 such that as float 251 rises or falls with the height of oil layer 124, float 251 rises or falls freely over the rod. In one embodiment, float 251 has a hole in the middle through which rod 230 is inserted, and float 251 is configured to travel the threaded rod with the variable height of oil layer 124. As the rod turns or moves in a vertical direction, the float is configured to remain substantially in the same place. As described in relation to FIG. 2A, mechanized surgical tool 254 is likewise mounted and/or coupled to threaded rod 230 (via fastener 255) and is configured to move up and down rod 230 as gear motor 212 moves the rod a certain amount of revolutions. In one embodiment, both the float system and mechanized surgical tool are each coupled to a pump, hose, and suction screen that is configured to retrieve one or more layers of fluid. In one embodiment, control system 150 is programmed to actuate each pump 214, 216 as appropriate based on readings from sensor 151. In another embodiment, mechanized surgical tool 254 can be coupled to a plurality of pumps and hoses, each one configured to pump out or retrieve a particular fluid layer. Thus, a single retrieval device can be used to retrieve fluid from a plurality of different layers in a given volume of fluid. Each retrieval device is configured to operate independently of each other.

FIG. 2D illustrates one embodiment of selective fluid retrieval system 204, which is non-mechanized. This embodiment combines a floating retrieval system (as described in FIG. 2B) with one or more vertically fixed retrieval section. In one embodiment, fluid retrieval system comprises float 251 coupled to hose 226 with suction screen 256, which operates substantially similar to the floating system described in relation to FIGS. 2B and 2C. As in the previously described floating system embodiments, float 251 is configured to float on or within upper oil layer 124 and rises and falls with the variable level of oil layer 124 and travels around pipe or hose 222. Retrieval system 204 also comprises one or more fixed suction points 263, 265, also coupled to pipe or hose 222. In one embodiment, suction screen 265 is at the bottom or end portion of pipe 222, such that it is located substantially within sludge layer 121. Because sludge layer 121 typically resides on the bottom portion of base tank 110, this embodiment is configured to remove a portion of the fluid from sludge layer 121 without any vertical movement of a float system or mechanized tool. In one embodiment, suction screen 263 is coupled to a vertical position on pipe 222 that is fixed and fluids may be retrieved from water layer 122 via hose 224 that is connected to pump 214. In one embodiment, fastener 275 is coupled to suction screen 263 or hose 224 to keep the hose (and the suction point) in a substantially fixed vertical position. The type of arrangement disclosed in FIG. 2D is useful in many situations, including those when the fluid height remains substantially constant and/or level.

### Control System

FIG. 3 is a schematic block diagram illustrating one embodiment of control system 150 that may be part of and/or coupled to selective fluid retrieval system 100 (as well as system 400 described in connection with FIG. 4). In one embodiment, control system 150 comprises computer system 310, communications system 322 (such as a modem for remote monitoring), and alarm 324, as well as any necessary air supplies, battery packs, and power lines. Any one or more of the control system logic and/or functions described in this disclosure may be implemented by control system 150. In one embodiment, an electrical line or circuit is coupled to each of the electronic components, devices, sensors, etc. found in retrieval system 100 and connected to control system 150, including recovery tanks, storage tanks, flow lines, and related components. In this way, each tank, motor, sensor, line, etc. of the disclosed retrieval system 100 may be integrally coupled to and managed by control system 150 such that control system 150 is able to monitor and control the fluid flow at many locations in the overall process flow.

Control system 150 may comprise or be coupled to pumps 332, 334, 336, 338, fluid height sensors 342, 344, gear motors 352, 354, and fluid sensors and/or flow meters 325, 326, 327, 328. For example, while not shown in FIG. 1 or 4, each piping or fluid conduit line of the disclosed retrieval system 100 may have one or more fluid sensors 325, 326, 327, 328 (such as conductivity, pH, temperature, pressure, ORP, gas, H2S, etc.) and flow meters. For simplicity, any data connections and/or control lines are not shown in FIGS. 1-4, as one of ordinary skill would understand how such lines are connected to each of the relevant electrical components and the control system. Measurements from the sensors and flow meters can provide real-time data on the fluid flowing within a particular line. Likewise, such sensors may also be placed before, within, or after any one or more of the tanks or containers, such as tanks 110, 132, 134, and 136. Fluid height/level sensors 342, 344 may also be coupled to the control system, such as sensor 151. For brevity, other components or systems that may be part of or coupled to control system 150 are not shown in FIG. 3, but one of ordinary skill in the art would know how, based on the particular design of the recovery system, such additional components may interface with control system 150.

Thus, in one embodiment, control system 150 is configured to know the amount and composition and other fluid characteristics within each point of the disclosed retrieval and treatment system. Based on this data, the control system is configured to monitor and make appropriate chemical injections (or other operations) in selected tanks or lines as necessary. If the retrieval and treatment system is directly coupled to a well, in some embodiments the control system is configured to provide guidance and/or information as to whether the well has switched from flowback to production or may have a potential problem.

In various embodiments, computer system 310 may be a server, a mainframe computer system, a workstation, a network computer, a desktop computer, a laptop, or the like. In other embodiments, computer system 310 may be implemented on a cloud-based datacenter system. Computer system 310 may include one or more processors 311 coupled to system memory 312 via a bus and data storage device 313, which may be internal or external to computer system 310. Computer system 310 may also includes a network interface and input/output (I/O) controller(s) 315 coupled to devices such as keyboard 314 and display(s) 316. In various embodiments, computer system 310 may be a single-processor system including one processor 311, or a multi-processor system including two or more processors. Processor(s) 311 may be any processor capable of executing program instructions. System memory 312 may be implemented using any suitable memory technology and be configured to store program instructions and/or data accessible by processor(s) 311. For example, memory 312 may be used to store software programs and/or databases. In other embodiments, program instructions and/or data may be received, sent or stored upon different types of computer-accessible media or on similar media separate from system memory 311 or computer system 310. Generally speaking, a computer-accessible medium may include any tangible, non-transitory storage media or memory media such as electronic, magnetic, or optical media—e.g., disk or CD/DVD-ROM coupled to computer system 310 or non-volatile memory storage (e.g., “flash” memory)

A person of ordinary skill in the art will appreciate that computer system 310 and control system 350 is merely illustrative and is not intended to limit the scope of the disclosure described herein. In particular, the computer system and devices may include any combination of hardware or software that can perform the indicated operations. In addition, the operations performed by the illustrated components may, in some embodiments, be performed by fewer components or distributed across additional components. Similarly, in other embodiments, the operations of some of the illustrated components may not be performed and/or other additional operations may be available. Accordingly, systems and methods described herein may be implemented or executed with other computer system configurations.

### Multi-Container Fluid Recovery and Treatment System

FIG. 4 illustrates another embodiment of fluid recovery and treatment system 400. While system 100 (see FIG. 1) is directed to a single base container or tank 110 in which fluid is retrieved and then routed to one or more storage tanks 132, 134, 136, the embodiment disclosed in system 400 (see FIG. 4) includes a plurality of fluid removal tanks 410, 420, 430, 440 in which one or more layers of fluid are removed. In one embodiment, a plurality of recovery tanks (shown in FIG. 4 from a simplified cross sectional diagram) is used to isolate and/or separate the layers or components of any waste water provided to system 400. The use of additional recovery tanks also provides additional volume capacity and different recovery configuration and control options.

In one embodiment, waste water or produced water is provided via trucks at one or more unload points or through direct piping from a well at fluid input conduit 1. Input fluid may be routed initially to chemical analysis and treatment station 452, which may be configured for various chemical treatment operations and/or analysis steps, including electro coagulation, resonant energy, and microwave and ultrasonic treatments. While in some embodiments the incoming wastewater is routed to lake tank 468 via conduit 3, in most embodiments the wastewater is routed to first fluid recovery tank 410 (which operates in a similar fashion to base tank 110 as described in relation to FIG. 1) via conduit 2. In route to recovery tank 410, optionally one or more chemicals or coagulant methods can be added to wastewater (such as in chemical treatment station 452) to facilitate separation of the wastewater into different layers prior to entry into recovery tank 410. Optionally, solids screen 414 can be mounted to tank 410 to facilitate removal of solids (such as sands, cement, cuttings, etc.) present in the wastewater. Any solids can be routed to roll-off container 458 and disposed of accordingly. Wastewater that enters recovery tank 410 eventually separates into various layers, as discussed in reference to FIG. 1.

In one embodiment, the wastewater is allowed to separate based upon a residence time, which for the purposes of this application is defined as the amount of time needed for fluids in a multi-component mixture to substantially separate into different substantially homogenous layers (such as a substantially water phase, a substantially sludge phase, and a substantially oil phase). In other words, the residence time is the time needed or allowed for a chemical to complete its intended effect or related chemical process (such as gravity settling) to occur. More residence time generally means a higher degree of separation for the fluid (e.g., the more separation of the fluid layers). In some embodiments each tank 410, 420, 430, 440 is substantially open such that the fluid layers may be allowed to separate by gravity into a plurality of fluid layers. In other embodiments one or more mechanical systems (such as static mixers, mechanical agitators, baffles, mesh systems, plate packs, centrifuges, and other similar liquid-liquid mechanical separation systems known to those of skill in the art) and non-mechanical systems (chemical treatments, electrical charging, coalescing, etc.) may be incorporated into the tank (or used prior to the fluid's entry into the tank) to facilitate fluid layer separation and decrease retention time.

Fluid recovery and treatment system 400 may also comprise or be coupled to control system 150. As in FIGS. 1 and 3, control system 150 may comprise or be coupled to a plurality of sensors, controls, and computer systems (with any necessary programming and instructions). In one embodiment, control system 150 is coupled to each of the recovery tanks, storage tanks, flow lines, and related components of system 400, and is able to monitor and control the fluid flow at all or substantially all of the locations in the overall system.

In one embodiment, recovery system 400 comprises two or more recovery tanks, such as primary recovery tank 410 and secondary recovery tank 420. In other embodiments, disclosed system 400 may comprise two, three, or more additional recovery tanks 420, 430, 440 for additional separation and recovery operations. Each recovery tank may comprise one or more sensors and one or more retrieval systems to retrieve one or more layers of fluid in the tank, and may also be configured to treat fluid in each tank to further aid in layer separation. Such treatment can be modified for each container based on the fluids within the container. In one embodiment, water from one of the plurality of recovery tanks (such as recovery tank 430) can be pumped to another storage container or tank (not shown) for shipping to another site for water re-use, and in other embodiments the water can be sent to lake tank 468 on the lease property via conduit 8 which can be re-used for other water needs (such as additional hydraulic fracturing operations). In some configurations, lake tank 468 may be coupled to a circulation pump connected to a treated water maintenance loop (not shown) with the tank that is connected to residual analyzer 454, which may be configured to analyze various properties of the fluid stream (pH, flow, TDS, chlorine dioxide, ozone, biocides, etc.) before routing to lake tank 468. Thus, depending on the fluid sent to and/or residing within lake tank 468, the fluid may be subsequently treated and/or monitored via a water maintenance loop (not shown). In some embodiments, residual analyzer 454 may treat the fluid and/or route it to one or more separate recovery tanks (such as tank 410) or containers for additional treatment or separation, including chemical analysis and treatment station 452.

In one embodiment, fluid recovery and treatment system 400 comprises one or more storage tanks for a particular fluid that may be coupled to one or more of the recovery tanks. For example, sludge tank 462 may be coupled to primary recovery tank 410 via conduit 6 and one or more other tanks (such as other layers tank 464) may be coupled to recovery tank 410 via conduit 7. Tanks 462, 464 may also be coupled to one or more of the other recovery tanks via additional conduits/piping. Similarly, one or more of the recovery tanks may be coupled to an oil tank or container for easy removal, disposal, or transportation of any recovered oil. For example, recovery tank 440 may be coupled to oil tank 466 via conduit 10, and all recovered oil from system 400 is routed to oil tank 466.

Fluid recovery and treatment system 400 may also comprise a plurality of selective retrieval systems 412, 422, 432 in one or more of recovery tanks 410, 420, 430, 440. Selective retrieval systems operate substantially similar to selective retrieval devices 142, 144, 146 described in relation to FIG. 1. For example, any of these devices may be any one or any combination of those retrieval devices shown in FIGS. 2A-2D. In one embodiment, each tank also comprises one or more sensors 411, 421, 431, 441 for measuring the height of each layer within the tank and is coupled to control system 150 and each of the respective retrieval systems within a tank. Each selective retrieval system is configured to selectively target and remove fluid from an individual layer and route that removed fluid to a separate tank. Such retrieval systems may be mechanized, non-mechanized, or a combination thereof (see FIGS. 2A-2D), and each recovery tank 410, 420, 430, 440 may include one, two, or three or more such retrieval systems. In some embodiments, such as for recovery tank 440, the tank may not need a selective retrieval system but may use another type of fluid removal device. In one embodiment, conduit 10 may be connected to tank 440 at a height to avoid any water or sludge that may be at the bottom of that tank. Similarly, a float system or fixed height suction device may be placed some distance above the bottom of tank 440 to remove only an upper oil layer (or, in some embodiments, only a water layer). The interaction of control system 150 and the selective retrieval systems (including pumps, floats, and mechanized surgical/robotic tools) operate in a substantially similar way as those components operate in relation to FIG. 1.

In one embodiment, selective retrieval system 412 is substantially similar to selective combination retrieval system 203 shown in FIG. 2C, which comprises a combined float system and mechanized robotic system. In other embodiments, a plurality of separate retrieval systems can be used (such as first retrieval system 201 and second retrieval system 202), each configured to retrieve fluid from a particular layer in the tank. In one embodiment, fluid from one or more layers can be retrieved into separate storage tanks. In other embodiments, each of the plurality of fluid layers within tank 410 is retrieved and/or recovered (or a portion thereof is retrieved and/or recovered) from that tank and sent to additional tanks for processing and/or storage. For example, assuming that the layers within tank 410 is substantially similar to the layers within tank 110 (see FIG. 1), one or more retrieval systems would remove a portion of oil layer 124 to oil tank 440, a portion of PAD layer 123 to recovery tank 464, a portion of sludge layer 121 to sludge tank 462, and a portion of water layer 122 to one or more additional recovery tanks 420, 430. For example, retrieval system 412 may comprise a first selective retrieval system (such as a floating system) that is configured to sit on top of or float within the oil layer and configured to retrieve oil and route recovered oil though conduit 419 (which may comprise an AOD or pump) to oil conduit 5 and oil recovery tank 440. Retrieval system 412 may also comprise a second retrieval system (such as a mechanized/robotic system) that is configured to retrieve fluid from the PAD layer and send it to tank 464 via conduit 6 (which may comprise an AOD or pump). In still other embodiments, a fixed retrieval system (which may or may not be coupled to or part of selective retrieval system 412) may be placed on the bottom of tank 410 to remove sludge from the sludge layer and may include a suction screen (such as suction screen 265 shown in FIGS. 2B and 2D). Sludge removed from sludge layer may be routed to sludge tank 162 via conduit 6.

In one embodiment, a portion of the fluid from one or more of the layers from tank 410 is circulated to tanks 420, 430, 440 for additional and/or enhanced recovery, separation, or isolation. In one embodiment, a portion of the oil layer or water layer from tank 410 may be transferred to tank 420, and after a period of separation, one or more retrieval systems 422 may retrieve oil from the separated oil layer and transfer it via conduit 429 to oil conduit 5. Similarly, a portion of the oil layer or water layer from tank 410 may be transferred to tank 430 (or, in some embodiments from tank 420 to tank 430), and after a period of separation, one or more retrieval systems 432 may retrieve oil from the separated oil layer and transfer it via conduit 439 to oil conduit 5. In one embodiment, oil conduit 5 is connected to each of the recovery tanks and provides a conduit for any recovered oil to be routed to a single location. While the fluid transported in oil conduit 5 may be all or substantially all oil, it may contain a small portion of other layers, such as water. This type of system may be desirable when water and other contaminants (such as solids) may be present in the removed oil stream. After one or more enhanced separation steps that are performed in the plurality of recovery tanks, any undesirable components may be removed from the one or more oil streams and be recycled to a holding tank or even a recovery tank for increased separation. For example, tank 441 may comprise fluid that is substantially oil, with a mix of other contaminants or components (such as water). After separation and processing in tank 440, oil is routed to oil storage tank 466 from conduit 10. In one embodiment, any excess water or contaminants is routed through conduit 11 (which may be configured as an excess water collection return) back to primary recovery tank 410 for additional processing or even analyzer 452 for further treatment or analysis. For example, if sensor 441 detects that the height of a water layer or other non-oil layer reaches a certain height or predetermined threshold, then control system 150 may activate a pump to transfer the water layer (as well as any other layer) back to the start of the separation and treatment process.

In one embodiment, a plurality (such as 3) of the plurality of recovery tanks may be coupled together via one or more pipeworks, such as manifold 456 or other similar mechanism. Manifold 456 allows the transfer of fluids from each of the interconnected recovery tanks. In one embodiment, manifold 456 may comprise a substantially straight piping section 456a that is connected to each of the connected tanks via one or more connecting sections 456b. While the connection height to each tank may vary, in one embodiment each connecting portion 456b is connected to a lower portion of each tank so as to not transport any oil (which typically floats on top of the other layers of fluids) and above the bottommost portion of each tank as to not transport any sludge (which typically resides on the bottom of the other fluid layers). Thus, in one embodiment, manifold 456 transports substantially a water layer between each of the connected recovery tanks 410, 420, 430. In one embodiment, only the water layer is substantially transferred between each of recovery tanks 410, 420, 430, and the oil layers within each tank are separately removed by one or more retrieval devices (such as by retrieval devices 412, 422, 432) and routed (such as by conduits 419, 429, 439) to a common oil conduit 5 that transfers recovered oil to oil tank 440. Thus, any oil present in the wastewater may be efficiently recovered in a number of processing steps, and excess water present in oil tank 440 can be circulated back to tank 410 or lake take 468 as appropriate.

In one embodiment, one of tanks 410, 420, 430 may be configured as a fluid level control tank or a weir tank that is interconnected to the other recovery tanks via manifold 456. In one embodiment and as shown in FIG. 4, recovery tank 430 is configured as a fluid level control tank that sets the height and/or maintains a constant height in other recovery tanks 410, 420. In one embodiment, recovery tank 430 sets the water height by any number of mechanisms, such as weir, baffles, dam check, or a plurality of vertical barriers 434. The fluid level within tank 420 may be adjustable via changing weir system 434. The fluid height control system may be external or internal to tank 420 and may be set manually or automatically, and in some embodiments may be regulated by control system 150. In one embodiment, weir system 434 comprises one or more vertical barriers, such that the length of each barrier and distance between barriers (and the container wall) is variable so as to set the fluid level control points. In one embodiment, water from tank 430 is re-circulated back to primary recovery tank 410, and in still other embodiments, based on readings from analyzer 454 and/or station 452, the amount of re-circulated water may be varied within recovery system 400 by control system 150.

Having a fixed or static fluid level in one or more of the containers is advantageous for numerous reasons. For example, various retrieval systems may be selectively positioned at fixed points (such as in the water layer or oil layer or sludge layer) to remove fluid from that layer without requiring a complicated system and operation of travelling a vertical distance within the fluid layers based on measured fluid layers. For example, if the fluid layer stays substantially the same, then a simple floating retrieval system may be used that sits at a fixed position on top of the fluids and/or merely sits on the top oil layer for selected oil recovery. In some cases, floats may be built to float on top of a water layer while being located under an oil layer. Further, the use of interconnected tanks allows for additional oil collection on top and increases the residence time capacity for fluids treatment and separation in one or more of the recovery tanks (e.g., the increased volume for fluid treatment may handle fluids that require larger residence time). In additional to an “internal” set point, such as a weir tank or internal baffle system, an “external” set point may be used, such as one or more pipeworks coupled to the outside of a recovery tank.

In one embodiment, the disclosed operations may be semi-automated in order to control the described processes, increase safety, promote efficiency, and prevent spillage or overflow at each tank. Flow meters, level controls, and transmitters may be used to prevent overflows in the tanks. In other embodiments, a plurality of sensors are utilized that can monitor one or more conditions of the system and/or process for local and/or remote monitoring. In one embodiment, one or more aspects of the process can be remotely managed via a network or the Internet. The disclosed process may operate continuously or in batches. For simplicity, the disclosed figures oftentimes do not show the data lines, valves, pumps, pipes, and joining pipe components necessary to combine the flows to and from the plurality of components, but such pipeworks and electrical connections are within the knowledge of one of ordinary skill in the art.

### Fluid Recovery Operation

FIG. 5 shows one embodiment of selective fluid recovery process 500 according to the disclosed embodiment. Fluid recovery method 500 first comprises receiving wastewater (such as produced water from an oil or gas well) with a plurality of components, as shown in step 502. The wastewater may comprise oil, water, contaminants and/or solids, and other components. The wastewater may be received at an input container or tank, such as tank 110 or tank 410, and may include a plurality of contaminants along with water and oil. The input tank may be remote to the source of wastewater or be on the same site as the oil or gas operation. Transportation to the input tank may be performed by train, trucks, or pipelines. The wastewater may or may be chemically treated prior to input into a separations tank, and solids may or may not be initially screened from the incoming waste fluid. In some embodiments, the wastewater may be processed by one or more mechanical separation techniques. The received wastewater is separated into a plurality of first layers in the input tank, as shown in step 504. There may be mechanical or chemical treatment to aid in separation. In one embodiment, the wastewater separates into a plurality of fluid layers, such as a substantially oil layer, a substantially PAD or intermediates layer, a substantially water layer, and a substantially sludge layer based on gravity settling. A selective retrieval device or system may be positioned into one or more of the first plurality of fluid layers, as shown in step 506. In some embodiments, a plurality of retrieval devices may be positioned into the plurality of fluid layers. In some embodiments, each retrieval device may be positioned into a plurality of fluid layers. The retrieval device may be mechanized and/or robotic, and may or may not include floats. In some embodiments, the retrieval device may be fixed at a single vertical point in the container (such as the sludge layer or the water layer), and in some embodiments the retrieval device is vertically moveable so to be selectively positioned in one or more of the fluid layers. A sensor may or may not be used to detect the heights of the fluid layers. In one embodiment, based on sensor measurements, a control system instructs the selective retrieval device to vertically move to a predetermined position and/or fluid layer within the input container. In one embodiment, based on sensor measurements, a control system instructs the selective retrieval device to pump and/or retrieve fluid at a given vertical height within the plurality of fluid layers. As shown in block 508, one or more of the fluid layers may be partially recovered and/or retrieved by the selective retrieval device(s). In one embodiment, most or substantially all of each fluid layer is initially recovered, while in other embodiments only a portion of the fluid layer is removed so as to not retrieve unwanted adjacent fluid layers. In one embodiment, based on sensor measurements, a control system instructs the selective retrieval device to pump and/or retrieve fluid at a given vertical height within the plurality of fluid layers. In other embodiments, a fixed retrieval device positioned in a layer of fluid may be selectively turned off and on to retrieve fluid from that layer. If no additional selective recovery is needed, then each of the fluid layers that have been recovered from the input container may be routed to one or more storage containers. If additional separation is desired for one or more of the retrieved fluids, then as shown in block 510, one or more of the separated fluid layers from initial input container 410 may be routed to a second (or more) container 420, 430, 440 for further separation of the retrieved fluid into a second plurality of fluid layers. In other words, while water or oil may be recovered from a first substantially water or oil layer, that layer may include non-oil or non-water components that need to be additionally separated. That recovered fluid may be allowed to separate into a second plurality of fluid layers based on chemical or mechanical treatment and/or simple gravity settling within a tank. After separation and similar to step 506, a selective retrieval device or system may be positioned into a fluid layer in each of the additional recovery tanks (such as 420, 430, 440), as shown in step 512. Multiple retrieval devices may be used, and each device may be configured to retrieve fluid from only a single fluid layer or may be configured to retrieve fluid from multiple fluid layers. In some embodiments, additional tanks and separation processes may be utilized. Once the desired amount of separation has been achieved, the plurality of fluid layers (such as the second plurality of fluid layers) may be individually recovered into one or more storage tanks (such as tanks 462, 464, 466), such as shown in step 514. For example, any separated oil from the oil phase may be sent to a storage container, any water may be sent to a lake or recycled water tank, and any intermediates layer (such as a PAD layer) may be sent to a tank for additional processing, storage, or transportation. In some embodiments, the recovered fluid may be re-processed and/or re-routed to other portions of the system for additional treatment, separation, and/or recovery.

All of the methods disclosed and claimed herein can be made and executed without undue experimentation in light of the present disclosure. While the apparatus and methods of this invention have been described in terms of preferred embodiments, it will be apparent to those of skill in the art that variations may be applied to the methods and in the steps or in the sequence of steps of the method described herein without departing from the concept, spirit and scope of the invention. In addition, modifications may be made to the disclosed apparatus and components may be eliminated or substituted for the components described herein where the same or similar results would be achieved. All such similar substitutes and modifications apparent to those skilled in the art are deemed to be within the spirit, scope, and concept of the invention.

Many other variations in the configurations of a node and the wireless systems on the node and/or vessel are within the scope of the invention. For example, the improved recovery system is able to interface with multiple configurations of produced water tanks and operations in the field. In one embodiment, the improved recovery system is able to operate at the well site, the lease, or any remote location that stores the produced water. The improved recovery system has low capital and operating costs, requires little power for operation, is extremely mobile, and is not limited by any intake volume limit of the produced water. While the recovery of oil is discussed in many of the disclosed embodiments, the disclosed selectively recovery device, system, and method is not limited to the recovery of oil and may be used in many other fluid treatment processes where fluid separation into a plurality of layers is desired and when selective positioning and retrieval of fluid from individual fluid layers is advantageous. It is emphasized that the foregoing embodiments are only examples of the very many different structural and material configurations that are possible within the scope of the present invention.

Although the invention(s) is/are described herein with reference to specific embodiments, various modifications and changes can be made without departing from the scope of the present invention(s), as presently set forth in the claims below. Accordingly, the specification and figures are to be regarded in an illustrative rather than a restrictive sense, and all such modifications are intended to be included within the scope of the present invention(s). Any benefits, advantages, or solutions to problems that are described herein with regard to specific embodiments are not intended to be construed as a critical, required, or essential feature or element of any or all the claims.

Unless stated otherwise, terms such as “first” and “second” are used to arbitrarily distinguish between the elements such terms describe. Thus, these terms are not necessarily intended to indicate temporal or other prioritization of such elements. The terms “coupled” or “operably coupled” are defined as connected, although not necessarily directly, and not necessarily mechanically. The terms “a” and “an” are defined as one or more unless stated otherwise. The terms “comprise” (and any form of comprise, such as “comprises” and “comprising”), “have” (and any form of have, such as “has” and “having”), “include” (and any form of include, such as “includes” and “including”) and “contain” (and any form of contain, such as “contains” and “containing”) are open-ended linking verbs. As a result, a system, device, or apparatus that “comprises,” “has,” “includes” or “contains” one or more elements possesses those one or more elements but is not limited to possessing only those one or more elements. Similarly, a method or process that “comprises,” “has,” “includes” or “contains” one or more operations possesses those one or more operations but is not limited to possessing only those one or more operations.

What is claimed is:

1. A system for the recovery of oil from wastewater from an oil or gas operation, comprising
an input container configured to receive wastewater, wherein the wastewater comprises water, oil, and contaminants, wherein the input container is configured to separate the wastewater into a plurality of fluid layers;
a plurality of storage tanks, wherein each storage tank is coupled to the input container and is configured to hold at least one fluid received from the input container;
a sensor coupled to the input container, configured to detect one or more of the plurality of fluid layers; and
a selective fluid recovery device in the input container, configured to retrieve at least some of the fluid in at least one of the plurality of fluid layers.

2. The system of claim 1, wherein the input container is a non-pressurized tank.

3. The system of claim 1, wherein the input container is a pressurized 3-phase separator.

4. The system of claim 1, wherein the plurality of fluid layers comprises a substantially oil layer, a substantially water layer, and a substantially sludge layer.

5. The system of claim 1, further comprising a control system coupled to the sensor and the selective fluid recovery device, wherein the selective fluid recovery device is configured to travel a plurality of vertical positions for fluid retrieval based on signals received by the control system.

6. The system of claim 1, wherein the sensor is configured to detect a height of each of the plurality of fluid layers at a plurality of times.

7. The system of claim 1, wherein the fluid recovery device is configured to retrieve at least some of the fluid in a plurality of the plurality of fluid layers.

8. The system of claim 1, wherein the fluid recovery device comprises a plurality of suction points, wherein each suction point is configured to retrieve fluid from a separate one of the plurality of fluid layers.

9. The system of claim 1, further comprising a plurality of fluid recovery devices, wherein a first fluid recovery device is configured to retrieve at least some of the fluid in a first fluid layer and the second fluid recovery device is configured to retrieve at least some of the fluid in a second fluid layer.

10. The system of claim 1, wherein the plurality of storage tanks comprises at least three tanks, wherein the first storage tank is configured to receive oil from the input container, wherein the second storage tank is configured to receive water from the input container, and wherein the third storage tank is configured to receive sludge from the input container.

11. A system for the selective recovery of fluid layers from wastewater, comprising
a plurality of recovery tanks, each configured to receive a fluid and separate the fluid into a plurality of fluid layers;
a plurality of storage tanks, coupled to one or more of the plurality of recovery tanks, that is configured to hold at least one fluid received from the plurality of recovery tanks; and
a plurality of selective fluid recovery devices configured to retrieve fluid from at least one of a plurality of fluid layers, wherein each of the plurality of recovery tanks comprises at least one of the plurality of selective fluid recovery devices.

12. The system of claim 11, wherein the plurality of recovery tanks is coupled together via a manifold, wherein the manifold is configured to fluidly connect a substantially water layer in each of the tanks.

13. The system of claim 11, wherein one of the plurality of recovery tanks is configured as a fluid level control tank that is configured to set the fluid level height in the remaining plurality of recovery tanks.

14. The system of claim 11, wherein the plurality of selective fluid recovery devices is configured to retrieve fluid from a substantially oil layer from each of the recovery tanks.

15. The system of claim 11, further comprising a plurality of sensors configured to detect a height of the plurality of fluid layers, wherein each of the plurality of recovery tanks comprises at least one of the plurality of sensors.

16. The system of claim 15, wherein each of the plurality of selective fluid recovery devices is configured to be selectively positioned in one of the plurality of fluid layers based upon measurements detected by at least one of the plurality of sensors.

17. The system of claim 11, wherein each of the plurality of selective fluid recovery devices is configured to selectively target and remove fluid from an individual fluid layer and route the removed fluid to a separate tank.

18. A fluid retrieval system for recovering fluids from wastewater, comprising
a sensor configured to detect a height of each of a plurality of fluid layers in a tank; and
a selective fluid recovery device configured to retrieve fluid from one or more of the plurality of fluid layers based on the detected heights.

19. The system of claim 18, wherein the fluid recovery device is configured to retrieve fluid from a plurality of the plurality of fluid layers.

20. The system of claim 18, wherein the fluid recovery device is configured to retrieve fluid from each of the plurality of fluid layers.

21. The system of claim 18, wherein the fluid recovery device is configured to retrieve at least some of the fluid in one of the plurality of fluid layers without retrieving substantially any of the fluid in the other fluid layers.

22. The system of claim 18, wherein the fluid recovery device is configured to target and retrieve fluid from a substantially oil layer of the plurality of fluid layers.

23. The system of claim 18, wherein the fluid recovery device is configured to target and retrieve fluid from a substantially water layer of the plurality of fluid layers.

24. The system of claim 18, wherein the fluid recovery device is configured to target and retrieve fluid from a substantially sludge layer of the plurality of fluid layers.

25. The system of claim 18, wherein the fluid recovery device comprises a plurality of suction points, wherein each suction point is configured to retrieve fluid from a different one of the plurality of fluid layers and route each of the retrieved fluids to a separate tank.

26. The system of claim 18, further comprising a float coupled to the fluid recovery device and configured to float on or within one of the plurality of fluid layers.

27. The system of claim 18, wherein the fluid recovery device is configured to travel vertically to selectively target one or more of the plurality of fluid layers based on measurements detected from the sensor.

28. The system of claim 18, wherein the sensor is configured to detect a height of each of the plurality of fluid layers continuously at a plurality of times.

29. The system of claim 18, further comprising a vertical member coupled to the selective retrieval device, wherein the fluid recovery device is configured to travel vertically along the vertical member.

30. The system of claim 29, wherein the vertical member is a threaded rod.

31. The system of claim 18, wherein the sensor is a radar sensor.

32. A method for treating used fluids from an oil or gas operation, comprising:
receiving one or more fluids at an input container, wherein the fluid comprises water, oil, and contaminants;
separating the received fluids into a plurality of fluid layers;
selectively positioning a retrieval device into at least one of the plurality of fluid layers; and
retrieving a fluid portion from at least one of the plurality of fluid layers through the one or more selective retrieval devices.

33. The method of claim 32, further comprising separating the received fluid into a substantially oil layer, a substantially water layer, and a substantially sludge layer, and selectively recovering a portion of each layer from the input container and delivering each of the recovered fluid layers into a separate tank.

34. The method of claim 32, further comprising determining the height of each of the plurality of fluid layers.

35. The method of claim 34, further comprising selectively positioning a retrieval device into at least one of the plurality of fluid layers based on the determined heights.

36. The method of claim 32, further comprising determining the height of each of the plurality of fluid layers at a plurality of times by detecting the height of each fluid layer with a radar sensor coupled to the input container.

37. The method of claim 32, wherein the retrieving step comprises removing fluid from one of the plurality of fluid layers without substantially removing fluid from the other layers.

38. The method of claim 32, further comprising positioning one or more selective retrieval devices into each of the plurality of fluid layers and recovering a fluid portion from each of the plurality of fluid layers through the one or more selective retrieval devices.

39. The method of claim 32, further comprising
removing one or more of the plurality of fluid layers into a plurality of recovery containers;
separating the fluid in each of the recovery containers into a plurality of additional fluid layers;
selectively positioning a retrieval device in one or more of the plurality of additional fluid layers; and
retrieving fluid from the one or more plurality of additional fluid layers by the one or more retrieval devices.
